(19) United States
(12) Patent Application Publication
(10) Pub. No.: US 2008/0303818 A1
(43) Pub. Date: Dec. 11, 2008

(54) MEDICAL IMAGE DISPLAY APPARATUS AND PROGRAM, AND RECORDING MEDIUM THEREFOR

(76) Inventor: Yoshiyuki MORIYA, Tokyo (JP)

Correspondence Address: BIRCH STEWART KOLASCH & BIRCH, PO BOX 747, FALLS CHURCH, VA, 22040-0747, US

(21) Appl. No.: 12/134,044

(22) Filed: Jun. 5, 2008

(30) Foreign Application Priority Data
Jun. 8, 2007 (JP) 2007-153215

(51) Int. Cl. G06T 15/20; G06K 9/00

(52) U.S. Cl. 345/427; 382/131

(57) ABSTRACT

With the present invention, using the schematic depiction of the tubular tissue in which the run path of the tubular tissue is adjusted so that the tubular tissues may not overlap, the information of the tubular tissue acquired from the volume image (three-dimensional image) is mapped onto this schematic depiction and displayed on the display device, whereby it is possible for the user to confirm all the information of the tubular tissue at a glance without need of performing an operation of rotating the displayed image in grasping the overall image of the tubular image.

### BACKGROUND OF THE INVENTION

1. Field of the Invention

The present invention relates to a medical image display apparatus and program, and a recording medium for the program. More particularly, the present invention relates to a technique for displaying information of a tubular tissue such as a blood vessel.

2. Description of the Related Art

Conventionally, a projected image processing apparatus is well known in which an MIP (Maximum Intensity Projection) image is generated by projecting the maximum value of a volume image (e.g., three-dimensional original image data constituted by a plurality of tomograms) of the subject acquired by an X-ray CT apparatus, and a tubular tissue such as a blood vessel is displayed three-dimensionally from this MIP image (Japanese Patent Application Laid-Open No. 7-303647).

Also, a volume rendering method is known as a method for displaying the medical image three-dimensionally (Japanese Patent Application Laid-Open No. 7-21405). The volume rendering method is the method of giving, as a pixel value of a projected point, a pixel value supposed to be reflected using the reflection and transmission based on the transparency, in consideration of the transparency for each tomogram as seen in the depth direction.

### SUMMARY OF THE INVENTION

In grasping the overall image of the tubular tissue, the three-dimensional (3D) image such as the MIP image as described in Japanese Patent Application Laid-Open No. 7-303647 or the volume rendering image as described in Japanese Patent Application Laid-Open No. 7-21405 is suitable for grasping the 3D shape, but there was a problem that information of the tubular tissue on the rear side can not be grasped in a portion where the tubular tissues overlap longitudinally in grasping information (thickness of tube, tumor, arctation, etc.) of the tubular tissue.

Therefore, it is required to grasp all the information of the tubular tissue by rotating the 3D image once (reconfiguring the 3D image by changing the projecting direction), whereby the information of the tubular tissue has to be grasped while performing an operation of rotating the 3D image, resulting in a problem that the operation is complex and takes a long time to grasp all the information of the tubular tissue. That is, there is a problem that all the information of the tubular tissue cannot be confirmed at a glance.

The invention has been achieved in the light of the above-mentioned circumstances, and it is an object of the invention to provide a medical image display apparatus, a medical image display program, and a recording medium for the program that allows the user to confirm all the information of the tubular tissue at a glance without need of performing an operation of rotating the displayed image in grasping the overall image of the tubular tissue.

In order to accomplish the above object, according to a first aspect of the invention, there is provided a medical image display apparatus comprising: an extraction device which extracts a tubular tissue from a volume image of a subject, an information acquisition device which acquires an information of the extracted tubular tissue, a position information acquisition device which extracts an anatomical first feature point of the extracted tubular tissue and acquires a three-dimensional positional information of the first feature point, a storage device which stores a two-dimensional schematic depiction of the tubular tissue in which a run path of the tubular tissue is adjusted so that the displayed tubular tissues may not overlap, the schematic depiction being associated with a positional information on the schematic depiction of an anatomical second feature point of the tubular tissues to be displayed, a mapping device which associates the first feature point with the second feature point and maps the acquired information of the tubular tissue to a corresponding position of the schematic depiction, based on a positional information of each of the associated feature points, and a display control device which displays the schematic depiction read from the storage device on a display device and displays the mapped information of the tubular tissue on the display device.

That is, the information of the extracted tubular tissue is acquired by extracting the tubular tissue from the volume image of the subject. Herein, the tubular tissue may comprise at least one of blood vessel, trachea, intestine, bile duct, pancreatic duct and lymphatic vessel as defined in the fifth aspect, and the information of the tubular tissue may comprise at least one of the cross-sectional area, major axis and minor axis of the tubular tissue, and thickness of a tube wall of the tubular tissue as defined in the sixth aspect. It is possible to confirm the thickness of tube, tumor, arctation and so on from this information of the tubular tissue.

The three-dimensional positional information of the first feature point is acquired by extracting the anatomical first feature point of the extracted tubular tissue. The first feature point is a portion (bifurcation given the anatomical name, etc.) having the anatomical feature of the tubular tissue.

On the other hand, a two-dimensional schematic depiction of the tubular tissue is prepared and stored in the storage device. In this schematic depiction (anatomical chart), the run path of the tubular tissue is adjusted so that the tubular tissues may not overlap each other. Also, the positional information on the schematic depiction of the anatomical second feature points of the tubular tissues displayed on the schematic depiction is stored associated with the schematic depiction.

The first feature point and the second feature point, which are in correspondence, are associated, whereby the positional information of the feature points is associated with each other. The acquired information of the tubular tissue is mapped to the corresponding position of the schematic depiction, based on the associated positional information of the first feature point and the second feature point (expanded over the schematic depiction).

The information of the tubular tissue mapped onto the schematic depiction in this way is displayed along with the schematic depiction on the display device. With the schematic depiction to which the information of the tubular tissue is added, it is possible to confirm all the information of the tubular tissue at a glance because the tubular tissues do not overlap.

According to a second aspect of the invention, the medical image display apparatus according to first aspect further comprises a pointing device which designates a tubular tissue at a desired position among the tubular tissues displayed on the display device, a tomogram acquisition device which acquires a tomogram including the designated tubular tissue from the volume image based on the positional information of the designated tubular tissue on the schematic depiction, and a device which displays the acquired tomogram on the display device.

For example, the cursor is moved to a tubular tissue of a desired position on the screen of the display device, and the position of a desired tubular tissue is designated on the schematic depiction by a click operation, whereby the tomogram including the designated tubular tissue is acquired from the volume image, based on the designated positional information on the schematic depiction. The tomogram acquired in this way can be displayed on the display device to confirm the detailed information of the desired tubular tissue. That is, with the schematic depiction and the volume image associated, the tomogram corresponding to an abnormal region can be displayed instantly in conjunction with an operation of designating the abnormal region on the schematic depiction, whereby the image reading becomes more efficient. The pointing devices for designating the position include a mouse, a cursor key of the keyboard, a touch pad, a track ball, and a joystick.

According to a third aspect of the invention, the medical image display apparatus according to second aspect further comprises a device which adds a marker indicating the position of the designated tubular tissue to the tomogram displayed on the display device. Thereby, it is possible to confirm instantly at which position on the tomogram the designated tubular tissue on the schematic depiction exists.

According to a fourth aspect of the invention, in the medical image display apparatus according to second or third aspect, the tomogram is at least one of an axial image, a coronal image, a sagittal image, a CPR image and an image orthogonal to the CPR image.

According to a seventh aspect, there is provided a medical image display program causing a computer to execute the functions of: extracting a tubular tissue from a volume image of the subject, acquiring an information of the extracted tubular tissue, extracting an anatomical first feature point of the extracted tubular tissue and acquiring a three-dimensional positional information of the first feature point, associating the first feature point with an anatomical second feature point of the tubular tissues to be displayed by using a two-dimensional schematic depiction of the tubular tissue stored in a storage device, the schematic depiction in which a run path of the tubular tissue is adjusted so that tubular tissues to be displayed may not overlap and a positional information of the schematic depiction of the second feature point, mapping the acquired information of the tubular tissue to a corresponding position of the schematic depiction, based on a positional information of each of the associated feature points, and displaying the schematic depiction read from the storage device on a display device and displaying the mapped information of the tubular tissue on the display device.

According to an eighth aspect, there is also provided a recording medium for the medical image display program. In the eighth aspect, the recording medium stores computer readable code of the medical image display program according to the seventh aspect.

### ADVANTAGES OF THE INVENTION

With the invention, using the schematic depiction of the tubular tissue in which the run path of the tubular tissue is adjusted so that the tubular tissues may not overlap, the information of the tubular tissue acquired from the volume image (three-dimensional image) is mapped onto this schematic depiction and displayed on the display device, whereby it is possible for the user to confirm all the information of the tubular tissue at a glance without need of performing an operation of rotating the displayed image in grasping the overall image of the tubular image.

### BRIEF DESCRIPTION OF THE DRAWINGS

FIG. 1 is a system configuration diagram of an image diagnosis support system comprising a medical image display apparatus according to the present invention;

FIG. 2 is a view for explaining a volume image (tomogram group);

FIG. 3 is a flowchart showing the overall flow of a medical image display process on the medical image display apparatus according to the invention;

FIG. 4 is a view showing one example of a schematic depiction of the blood vessels;

FIG. 5 is a flowchart showing a mapping process for the blood vessel to the schematic depiction of information of the blood vessels;

FIG. 6 is a view showing the contrast between the feature points extracted from the blood vessels and the feature points of the blood vessel regions in the schematic depiction;

FIG. 7 is a chart showing information of the feature point extracted from the blood vessel;

FIG. 8 is a chart showing information of the feature point of the blood vessel region in the schematic depiction;

FIG. 9 is a view showing one example of representing information (cross-sectional area or diameter) of the blood vessel in terms of the thickness of the blood vessel (line) on the schematic depiction;

FIG. 10 is a flowchart showing a process for displaying the tomogram in conjunction with an operation in the schematic depiction; and

FIG. 11 is a view for explaining the types of bifurcation of aorta from an aoitic arch.

### DETAILED DESCRIPTION OF THE PREFERRED EMBODIMENTS

The preferred embodiments of a medical image display apparatus, a medical image display program, and a recording medium for the program according to the present invention will be described below with reference to the accompanying drawings.

<System Configuration>

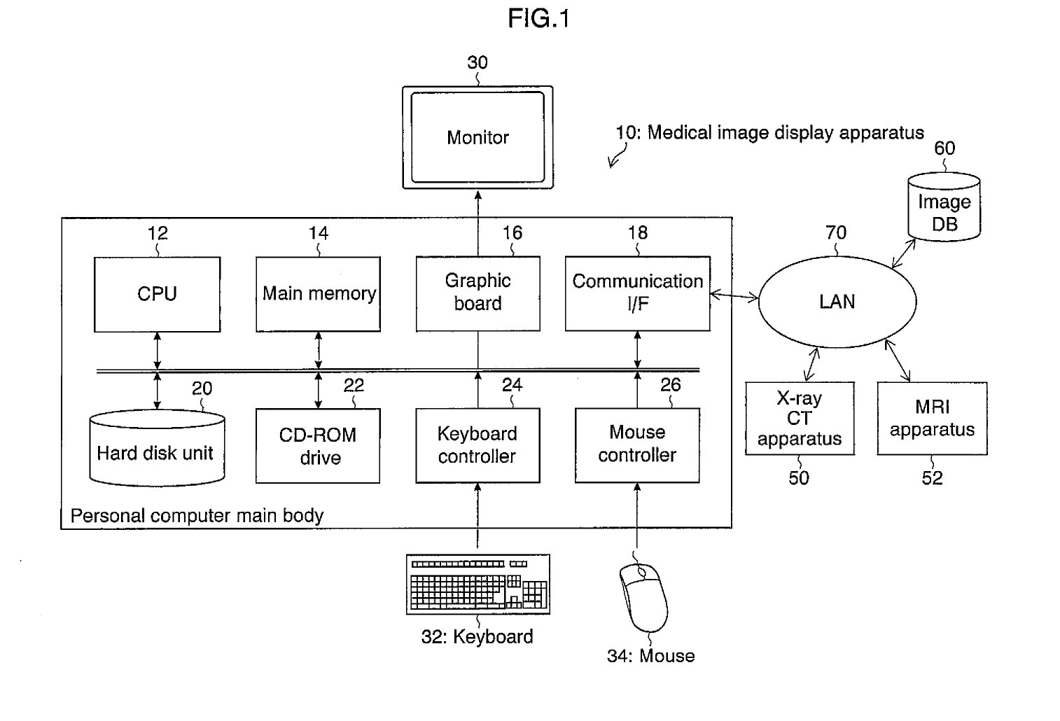

FIG. 1 is a system configuration diagram of an image diagnosis support system comprising a medical image display apparatus according to the present invention.

The image diagnosis support system mainly includes a medical image display apparatus 10 operated by the user such as a radiographic interpreter or clinician, an X-ray CT apparatus 50, an Mid apparatus 52, an image database (image DB) 60, and a network 70 such as a hospital LAN that connects them.

The medical image display apparatus 10 is a personal computer (PC), mainly comprising a central processing unit (CPU) 12 for controlling the operation of each component, a main memory 14 that stores a control program of the system or serves as a work area in executing the program, a graphic board 16 for controlling the display of a monitor unit 30 such as a liquid crystal display or a CRT display, a communication interface (communication I/F) 18 connected to the network 70, a hard disk unit 20 for storing various kinds of application software including an operating system (OS) of the personal computer, a device driver of a peripheral device connected to the personal computer, a medical image display program according to the invention, and data of a schematic depiction of the tubular tissue such as a blood vessel of the human body, a CD-ROM drive 22, a keyboard controller 24 for detecting a key operation on the keyboard 32 and outputting it as an input instruction to the CPU 12, and a mouse controller 26 for detecting a state of a mouse 34 as a pointing device for inputting the position and outputting signals of the position of a mouse pointer or a state of the mouse 34 on the monitor unit 30 to the CPU 12.

Since the personal computer with the above configuration is well known except for the medical image display program according to the invention and data of the schematic depiction, which are stored in the hard disk unit 20, the detailed explanation of each component is omitted.

Incidentally, the medical image display program according to the present invention can be provided as a recording medium (a hard disk unit, a CD-ROM disk, a DVD disk, etc.) in which computer readable code for the program is stored.

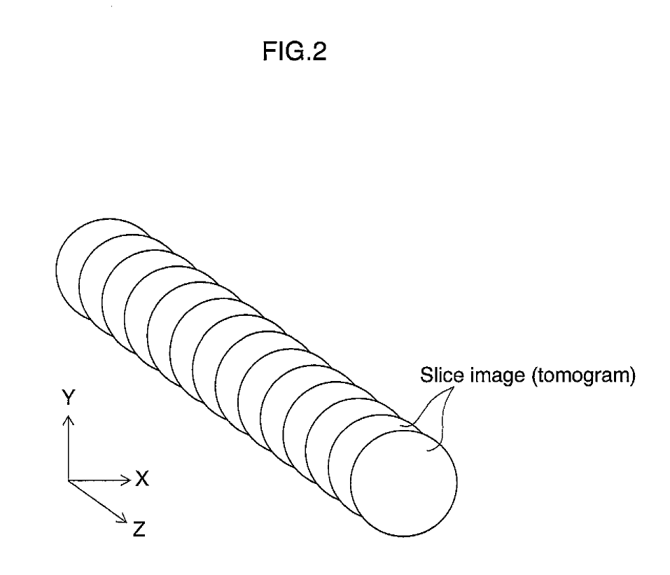

Each of the X-ray CT apparatus 50 and the MRI apparatus 52 takes a large number of slice images (tomograms) continuous along the Z axis direction (axial direction of the subject), as shown in FIG. 2. A group of tomograms (hereinafter referred to as a “volume image”) taken by each of the X-ray CT apparatus 50 and the MRI apparatus 52 is stored in the image DB 60.

The image DB 60 stores and manages the volume image taken by each of the X-ray CT apparatus 50 and the MRI apparatus 52 associated with the patient name, radiographing date and time, radiographing region and so on.

The user operates the medical image display apparatus 10 to acquire the volume image via the network 70 from the image DB 60, creates a medical image from the volume image to display it on the monitor unit 30, and interprets the image displayed on the monitor unit 30 to create an image reading report or a clinical record.

### First Embodiment

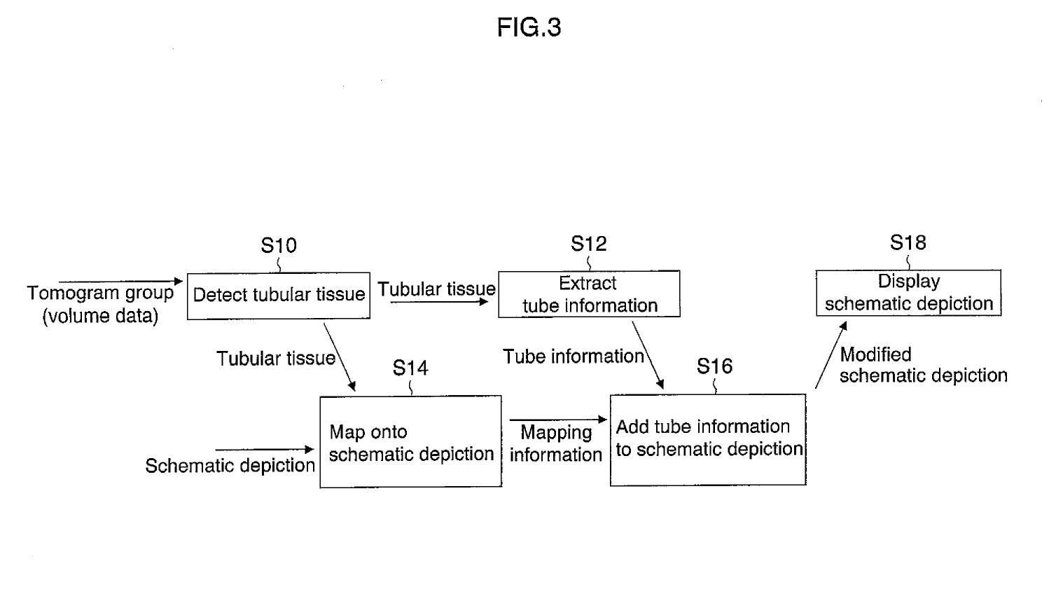

FIG. 3 is a flowchart showing the overall flow of a medical image display process on the medical image display apparatus according to the invention. This process is performed by starting the medical image display program.

The user manipulates the keyboard 32 or mouse 34 of the medical image display apparatus 10 to input the patient name, radiographing date and time, radiographing region and so on, and a desired tomogram group (volume image) is retrieved from the image DB 60 into the medical image display apparatus 10 based on the input information.

The medical image display apparatus 10 processes the retrieved volume image to detect (extract) a tubular tissue (step S10). In this embodiment, the tubular tissue is a blood vessel as an example.

As a method for extracting the blood vessel from the volume image, a technique as described in Japanese Patent Application Laid-Open No. 8-89501 can be applied. That is, when the blood vessel is extracted from the volume image, a process for tracking the center of a blood vessel region in the volume image is performed to acquire blood vessel tracking data (data of the blood vessel center line). And a density gradient from a noticed point of the blood vessel center line outwards (radially) is calculated, and a blood vessel verge is decided using the density gradient. The blood vessel can be extracted by performing the above process while moving the noticed point along the blood vessel center line. A technique for separating an anatomical structure (e.g., respiratory tract) as described in Japanese Patent Application Laid-Open No. 2004-174263 can be applied to the method for extracting the tubular tissue.

Subsequently, the blood vessel information is extracted (step S12). The blood vessel information includes basic shape information such as a cross-sectional area of the blood vessel, a blood vessel diameter (length, breadth) and so on, and functional data (that can be acquired by the MRI image) such as thickness of a blood vessel wall, and the blood volume. In Japanese Patent Application Laid-Open No. 2004-174263, a technique for measuring the information such as the area and wall thickness of the tubular anatomical structure was described.

On the other hand, the hard disk unit 20 stores the schematic depiction (anatomical chart) of the blood vessel that is created beforehand. This schematic depiction is read from the hard disk unit 20 when the medical image is displayed.

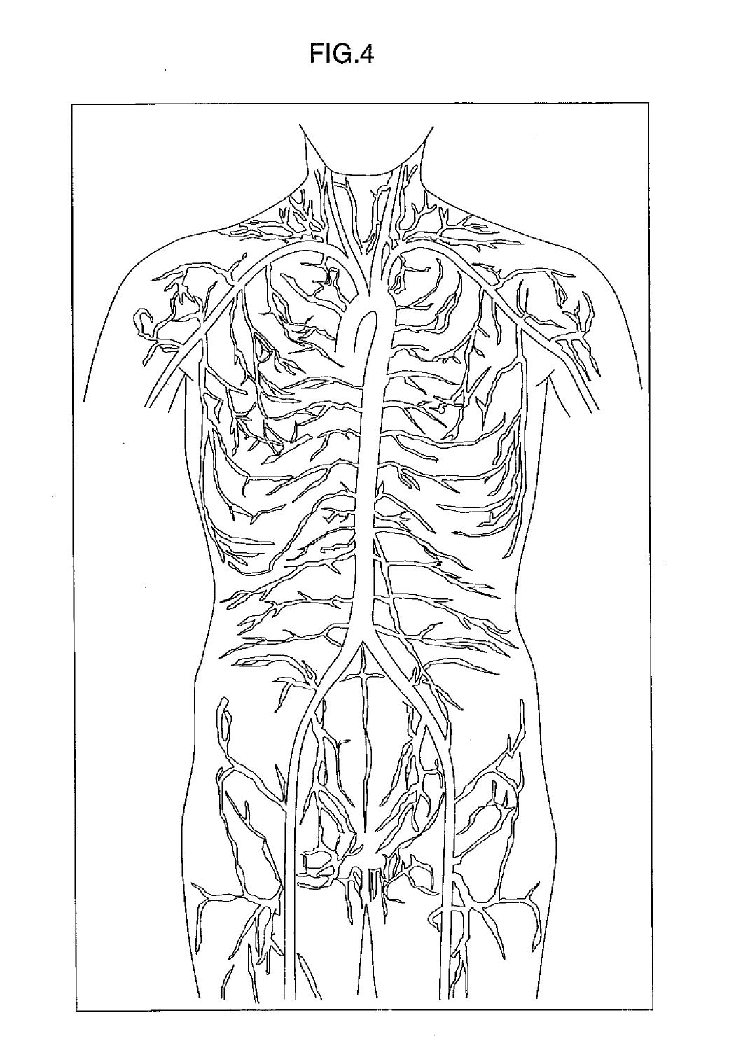

FIG. 4 shows one example of the schematic depiction of the blood vessels. This schematic depiction represents the blood vessels in two dimensions, in which the run paths of the blood vessels are adjusted so that the blood vessels may not overlap. Also, the bifurcation position of the blood vessel is adjusted so that it may not be located on the back side of the blood vessel. It is difficult to create the schematic depiction so that all the blood vessels including the minute blood vessel such as blood capillary may not overlap, whereby the schematic depiction is created so that the blood vessels above a certain thickness (e.g., blood vessel given the anatomical name or blood vessel in which the run path of blood vessel is almost determined) only may not overlap.

Subsequently, the mapping information for associating the blood vessel extracted at step 810 with the blood vessel on the schematic depiction is acquired (step S14). The details of mapping onto the schematic depiction will be described later.

Then, the information of blood vessel acquired at step S12 is mapped to the corresponding blood vessel position of the schematic depiction, based on the mapping information acquired at step S14, to modify the schematic depiction (step S16). The modified schematic depiction modified in this way is displayed on the monitor unit 30 (step S18).

[Mapping Onto Schematic Depiction]

A mapping method for the blood vessel information onto the schematic depiction will be described below.

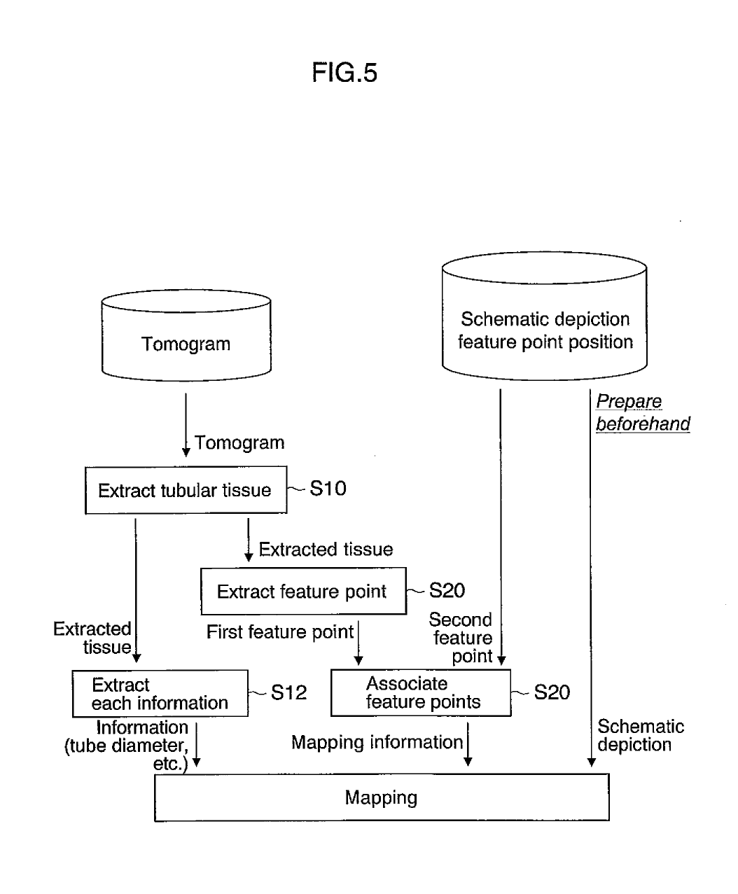

FIG. 5 is a flowchart showing a mapping process for the blood vessel information onto the schematic depiction. The same step numbers are assigned to the steps making the same process as in the flowchart as shown in FIG. 3, the explanation of which is omitted.

If the blood vessel is extracted at step S10, the feature point (first feature point) of the blood vessel is extracted (step S20). This first feature point is a point (such as a bifurcation given the anatomical name) corresponding to a portion of the blood vessel having an anatomical feature.

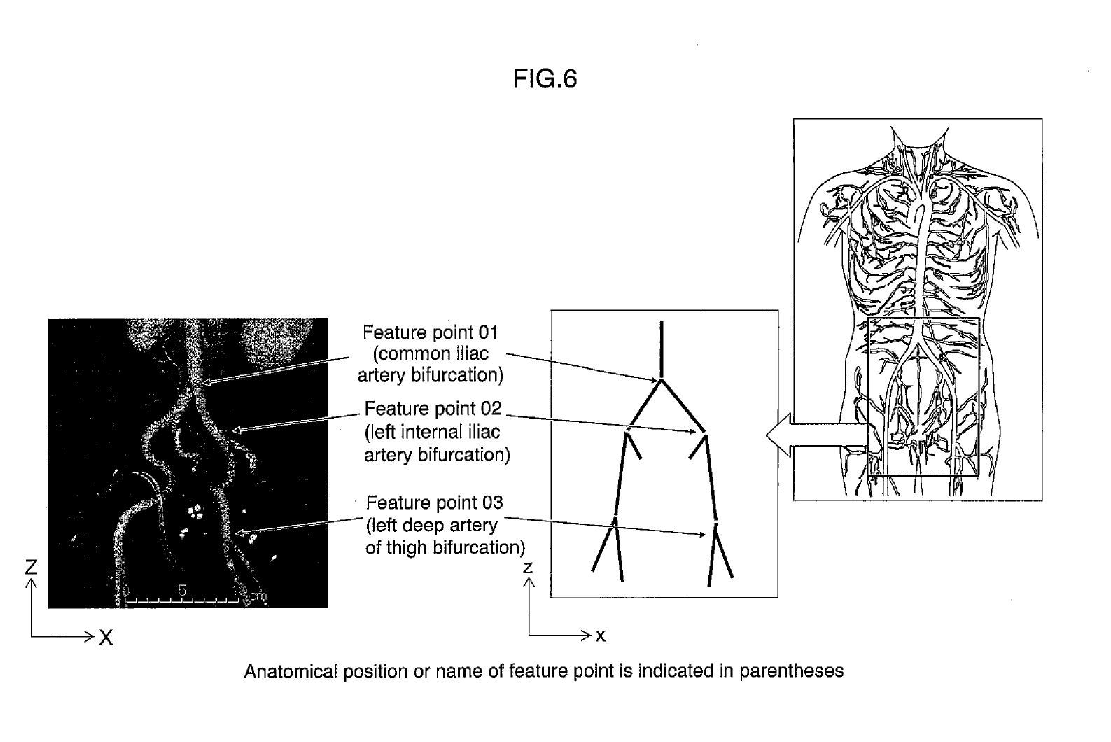

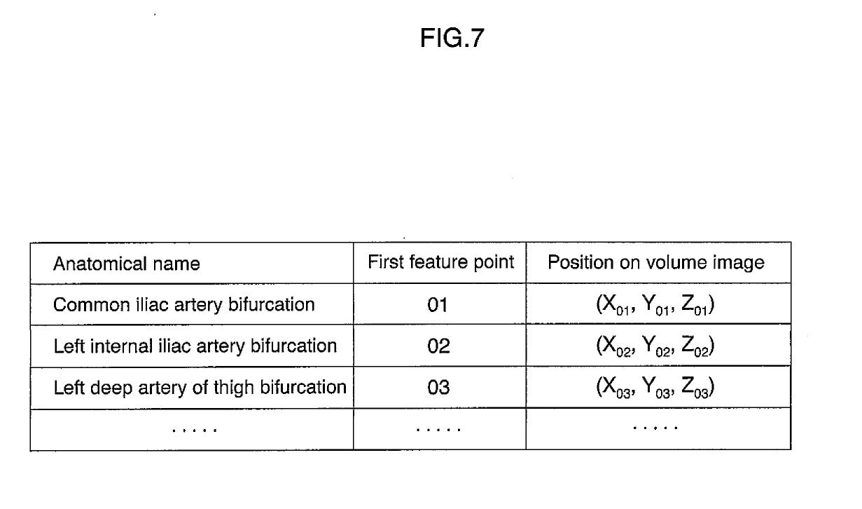

FIG. 6 shows the feature point extracted from the blood vessel and the feature point of the blood vessel region in the schematic depiction. The feature points 01, 02, 03, . . . extracted from the blood vessels have the specified positions on the volume image, and are stored associated with the volume image in the hard disk unit 20, as shown in FIG. 7.

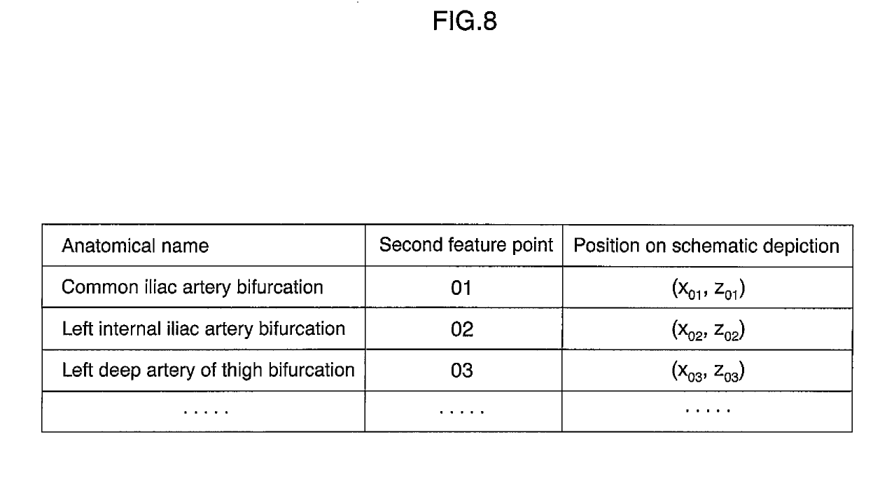

As for the schematic depiction, the positional information (positional information indicating the position on the schematic depiction) of the feature point (second feature point) of the blood vessel is stored associated with the schematic depiction, as shown in FIG. 8.

At step S20, the first feature point and the second feature point are associated, and various kinds of information on the blood vessel are mapped onto the schematic depiction, based on the correspondence information (mapping information) between the first and second feature points.

For example, when the information of the blood vessel between the first feature point 01 and the first feature point 02 is mapped onto the blood vessel portion between the second feature point 01 and the second feature point 02 on the schematic depiction, the distance L1 between the first feature point 01 and the first feature point 02 along the blood vessel center line and the distance L2 between the second feature point 01 and the second feature point 02 along the blood vessel center line are obtained.

And when the information of the blood vessel at the position the distance X from the first feature point 01 is mapped onto the schematic depiction, it is mapped to the position the distance x (distance from the second feature point 01) as indicated in the following expression.

x=(L2/L1)·X [Formula 1]

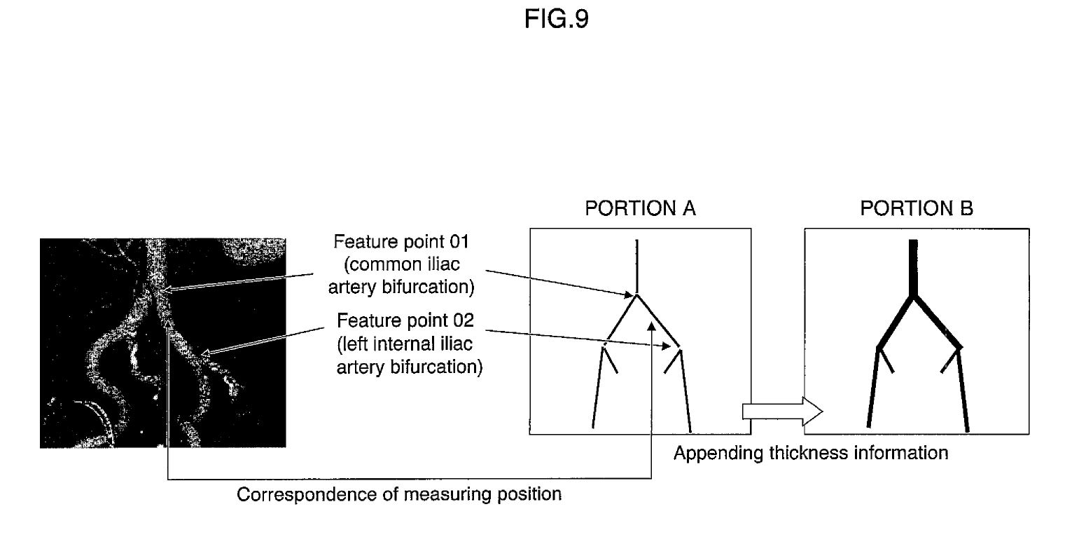

FIG. 9 shows one example of representing the information (cross-sectional area or diameter) of the blood vessel in the thickness of the blood vessel (line) on the schematic depiction.

That is, a portion A in FIG. 9 shows a schematic depiction in which the information of the blood vessel is not given, and a portion B in FIG. 9 shows a modified schematic depiction to which the information (cross-sectional area or diameter) of the blood vessel is added as the thickness information of the line.

Also, the blood vessel portion may be color-coded in the schematic depiction. For example, the blood vessel portion where there is a large blood volume is color-coded as red, and the blood vessel portion where there is a small blood volume is color-coded as blue, whereby the information of the blood volume in the blood vessel can be given to the schematic depiction.

A combination of information of the blood vessel may be given to the schematic depiction to represent the cross-sectional area or diameter of the blood vessel in the thickness of the line, and the blood volume in color.

The modified schematic depiction to which the information of the blood vessel is added in this way is displayed on the monitor unit 30, whereby the user can confirm various kinds of information on the blood vessel, such as an arctation portion where the blood vessel diameter is narrower, a portion where the blood volume is smaller, and a tumor from the schematic depiction of the overall image of the blood vessels at a glance.

### Second Embodiment

With the schematic depiction, the overall image of the blood vessels can be grasped at a glance to specify an abnormal region, but it is required to observe the tomogram to interpret the abnormal region minutely.

A function of simply displaying the tomogram corresponding to the region specified on the schematic depiction in interpreting the schematic depiction will be described below.

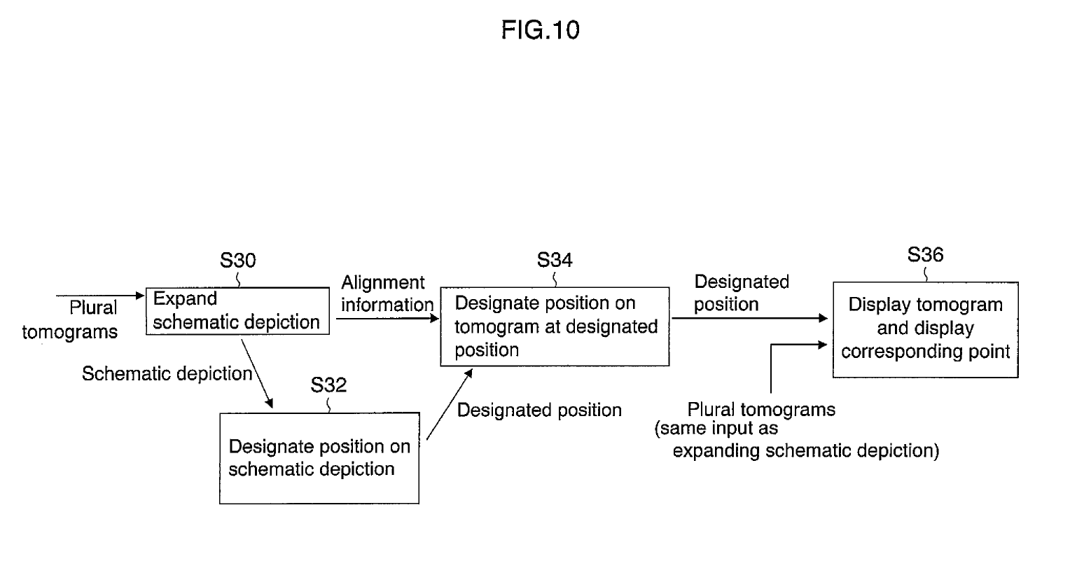

FIG. 10 is a flowchart showing a process for displaying the tomogram in conjunction with an operation in the schematic depiction.

As described above, various kinds of information on the blood vessel are mapped (expanded) onto the schematic depiction, and the modified schematic depiction is displayed on the monitor unit 30 (step S30).

Also, in expanding the information of the blood vessel over the schematic depiction, the coordinates (coordinates on the schematic depiction) of the point on the center line of the blood vessel on the schematic depiction and the coordinates (coordinates on the volume image) of the point on the center line of the blood vessel within the volume image are stored as the set by associating the coordinates of each point in the schematic depiction and the volume image. That is, it is shown in FIGS. 7 and 8 that the coordinates of the corresponding feature point on the volume image and the schematic depiction are stored, but the coordinates of the point on the center line of the blood vessel on the schematic depiction and the coordinates of the corresponding point on the center line of the blood vessel within the volume image are stored as the set in the same way.

The user moves the mouse pointer to the blood vessel (abnormal region) at a desired position on the screen of the monitor unit 30, and designates the desired position of the blood vessel on the schematic depiction by click operation (step S32).

Since the coordinates of the point on the center line of the blood vessel on the schematic depiction and the coordinates of the corresponding point on the center line of the blood vessel within the volume image are stored as the set, if the position (coordinates) of the blood vessel on the schematic depiction is designated at step S32, the position (coordinates) of the blood vessel on the volume image corresponding to this coordinates can be obtained. If the three-dimensional coordinates of the blood vessel on the volume image are specified, the Z coordinate of the three-dimensional coordinates corresponds to the slice position of the tomogram (see FIG. 2), whereby the tomogram can be specified from the volume image. Also, the position of the blood vessel on the specified tomogram can be specified from the X coordinate and the Y coordinate (step S34).

The tomogram specified in this way is displayed on the monitor unit 30, and a marker indicating the specified position of the blood vessel on the tomogram is displayed (step S36). The marker may be a cursor such as the arrow, or a frame surrounding the corresponding point of the blood vessel.

### Modified Embodiment

Though the tomogram displayed in conjunction with the schematic depiction is the tomogram (axial image) orthogonal to the axial direction of the subject in the above embodiment, furthermore a three side image of the axial image, the coronal image orthogonal to the axial image and passing through the designated position of the blood vessel and the sagittal image, a CPR (Curved Planar Reconstruction) image and the tomogram orthogonal to it may be displayed.

The CPR image is the image of cutting the volume image across the sectional curved plane along the center line of the blood vessel, and further elongating the curve, and suitable for observing the cross-section of the blood vessel along the blood vessel. A method for creating the CPR image may employ the techniques as described in Japanese Patent Application Laid-Open No. 2001-14495 and Japanese Patent Application Laid-Open No. 2004-283373.

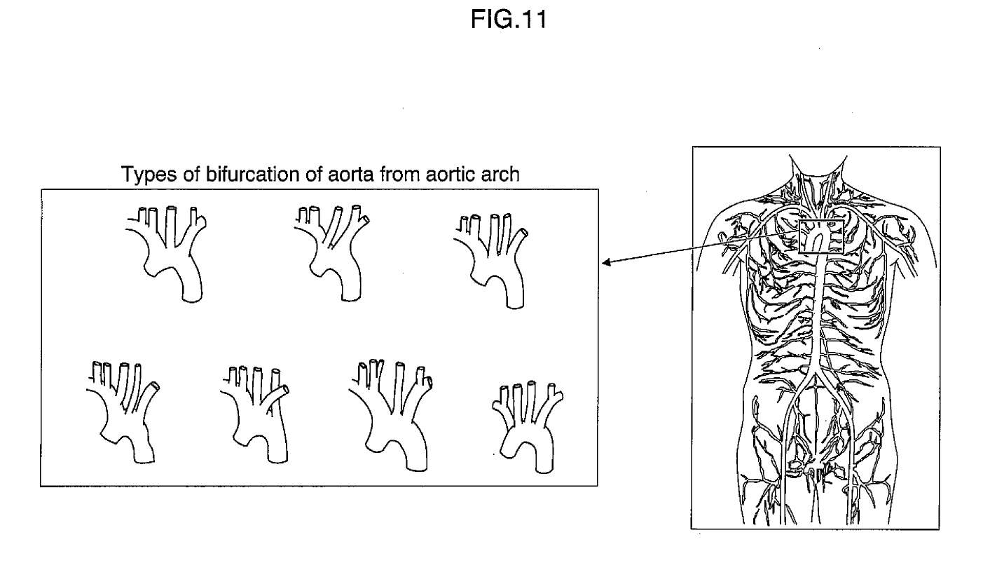

Though the representative schematic depiction of the blood vessel is prepared beforehand in this embodiment, the structure may not be matched with the single schematic depiction because there are individual differences (normal displacements) in the way of bifurcation of the blood vessel. For example, an artery bifurcation structure from the aortic arch has a plurality of bifurcation types, as shown in FIG. 11. Also, there are individual differences in the number of arteries leading to kidney.

As a measure for this, there is a method for selecting the corresponding schematic depiction from among plural schematic depictions prepared according to the subject. Also, plural partial schematic depictions are provided for each part of the human body, and the overall schematic depiction is configured by combining them suitably to provide the schematic depiction corresponding to the subject.

Which schematic depiction is employed among the plural schematic depictions is decided by a method as described in the following reference document.

Shinya Ema, “Improved model selection method in automatic correspondence of bronchial tube name”, The Institute of Electronics, Information and Communication Engineers, Shingakugiho (Technical Report of JEJCE) MI2004-110(2005-1). Also, if any of the prepared schematic depictions do not conform, an error message or the like may appear.

Further, the invention is not limited to the blood vessel, but may be also applied to the case of displaying information on other tubular tissues such as trachea, intestine, bile duct, pancreatic duct, and lymphatic vessel.

Furthermore, the volume image is not only acquired via the network 70 such as a hospital LAN from the image DB 60 within the hospital, but may be acquired via a secure external network such as IPSec or SSL-VPN from an external image DB.

What is claimed is:

1. A medical image display apparatus comprising:
an extraction device which extracts a tubular tissue from a volume image of a subject;
an information acquisition device which acquires an information of the extracted tubular tissue;
a position information acquisition device which extracts an anatomical first feature point of the extracted tubular tissue and acquires a three-dimensional positional information of the first feature point;
a storage device which stores a two-dimensional schematic depiction of the tubular tissue in which a run path of the tubular tissue is adjusted so that tubular tissues to be displayed may not overlap, the schematic depiction being associated with a positional information on the schematic depiction of an anatomical second feature point of the tubular tissues to be displayed;
a mapping device which associates the first feature point with the second feature point and maps the acquired information of the tubular tissue to a corresponding position of the schematic depiction, based on a positional information of each of the associated feature points; and
a display control device which displays the schematic depiction read from the storage device on a display device and displays the mapped information of the tubular tissue on the display device.

2. The medical image display apparatus according to claim 1, further comprising:
a pointing device which designates a tubular tissue at a desired position among the tubular tissues displayed on the display device;
a tomogram acquisition device which acquires a tomogram including the designated tubular tissue from the volume image based on the positional information of the designated tubular tissue on the schematic depiction; and
a device which displays the acquired tomogram on the display device.

3. The medical image display apparatus according to claim 2, further comprising a device which adds a marker indicating the position of the designated tubular tissue to the tomogram displayed on the display device.

4. The medical image display apparatus according to claim 2, wherein the tomogram is at least one of an axial image, a coronal image, a sagittal image, a CPR image and an image orthogonal to the CPR image.

5. The medical image display apparatus according to claim 3, wherein the tomogram is at least one of an axial image, a coronal image, a sagittal image, a CPR image and an image orthogonal to the CPR image.

6. The medical image display apparatus according to claim 1, wherein the tubular tissue comprises at least one of blood vessel, trachea, intestine, bile duct, pancreatic duct and lymphatic vessel.

7. The medical image display apparatus according to claim 5, wherein the tubular tissue comprises at least one of blood vessel, trachea, intestine, bile duct, pancreatic duct and lymphatic vessel.

8. The medical image display apparatus according to claim 1, wherein the information of the tubular tissue comprises at least one of a cross-sectional area, major axis and minor axis of the tubular tissue, and thickness of a tube wall of the tubular tissue.

9. The medical image display apparatus according to claim 7, wherein the information of the tubular tissue comprises at least one of a cross-sectional area, major axis and minor axis of the tubular tissue, and thickness of a tube wall of the tubular tissue.

10. A medical image display program causing a computer to execute the functions of:
extracting a tubular tissue from a volume image of a subject;
acquiring an information of the extracted tubular tissue;
extracting an anatomical first feature point of the extracted tubular tissue and acquiring the three-dimensional positional information of the first feature point;
associating the first feature point with an anatomical second feature point of the tubular tissues to be displayed by using a two-dimensional schematic depiction of the tubular tissue stored in a storage device, the schematic depiction in which a run path of the tubular tissue is adjusted so that tubular tissues to be displayed may not overlap and a positional information on the schematic depiction of the second feature point;
mapping the acquired information of the tubular tissue to a corresponding position of the schematic depiction, based on a positional information of each of the associated feature points; and
displaying the schematic depiction read from the storage device on a display device and displaying the mapped information of the tubular tissue on the display device.

11. A recording medium in which computer readable code of the medical image display program according to claim 10 is stored.
